(19) United States
(12) Patent Application Publication
(10) Pub. No.: US 2026/0035531 A1
(43) Pub. Date: Feb. 5, 2026

(54) METHOD FOR PRODUCING RECLAIMED POLYCARBONATE RESIN

(71) Applicant: MITSUBISHI GAS CHEMICAL COMPANY, INC., Tokyo (JP)

(72) Inventors: Takashi FUJII, Tokyo (JP); Hidetaka SHIMIZU, Tokyo (JP); Maki ITO, Tokyo (JP)

(73) Assignee: MITSUBISHI GAS CHEMICAL COMPANY, INC., Tokyo (JP)

(21) Appl. No.: 19/119,510

(22) PCT Filed: Nov. 20, 2023
(86) PCT No.: PCT/JP2023/041608

§ 371 Date: Apr. 9, 2025

(30) Foreign Application Priority Data
Nov. 25, 2022 (JP) 2022-188275

(51) Int. Cl. C08J 11/08

(52) U.S. Cl. CPC C08J 11/08; C08J 2369/00

(57) ABSTRACT

The present invention can provide a method for producing a reclaimed polycarbonate resin from a waste resin composition at least containing a polycarbonate resin, the method including a step in which the waste resin composition is dissolved in an organic solvent and the solution is filtered to prepare a 1-30 mass % resin solution and a step in which the obtained resin solution is passed through a column chromatograph to fractionate a reclaimed polycarbonate resin.

### TECHNICAL FIELD

The present invention relates to a recycling technology for polycarbonate resins, and particularly relates to a method for continuously producing a high-quality reclaimed polycarbonate resin from a resin product (molded body, etc.) containing a waste polycarbonate resin.

### BACKGROUND ART

In recent years, working on reduction in the amounts of wastes by promoting the 3Rs (Reduce, Reuse, Recycle) and appropriate disposal of wastes in compliance with the laws has become an important problem for companies.

Regarding recycling of polycarbonate resins, many patent applications of technologies including a technology for performing decomposition for recovery as bisphenol A have been filed intermittently since around 2000 (Patent Documents 1 to 3).

Patent Document 1 discloses a method in which an organic solvent solution of a polycarbonate resin is mixed with an aqueous solution of a chelating agent, the obtained mixture is stirred, then an organic solvent solution phase is separated, and the polycarbonate resin is recovered from the organic solvent solution phase. However, according to this method, it is impossible to separate impurities dissolved in the organic solvent, and in addition, it is impossible to perform separation into polycarbonate resins having different viscosity average molecular weights.

Patent Document 2 discloses a chemical recycling method for polycarbonate resins, and Patent Document 3 discloses a method for producing a bisphenol by utilizing the decomposition of a polycarbonate resin. However, it cannot be necessarily said that the methods of Patent Documents 2 and 3 are environmentally friendly since these methods require long steps and high energy consumption.

Furthermore, for commercialization, the quality of recycled products is required to be equal to or higher than the quality of original products, and further technological innovation has been demanded.

### PRIOR ART DOCUMENTS

### Patent Documents

Patent Document 1: Japanese Laid-Open Patent Publication No. 2001-261812
Patent Document 2: Japanese Laid-Open Patent Publication No. 2003-171324
Patent Document 3: WO2022/092176

### SUMMARY OF THE INVENTION

### Problems to be Solved by the Invention

The present invention addresses the problem of solving at least one of the above-described conventional problems. The present invention further addresses the problem of obtaining a high-quality reclaimed polycarbonate resin from a resin product (molded body, etc.) containing a waste polycarbonate resin continuously without high energy consumption by a simple method.

### Means for Solving the Problems

The present inventors diligently made researches in order to solve the conventional problems and found that, by passing a specific resin solution through a column chromatograph, a high-quality reclaimed polycarbonate resin can be fractionated continuously without high energy consumption by a simple method, and thus the present invention was achieved.

Specifically, the present invention includes aspects described below.

<1> A method for producing a reclaimed polycarbonate resin from a waste resin composition containing at least a polycarbonate resin, the method including:
a step of dissolving the waste resin composition in an organic solvent and performing filtration to prepare a 1 to 30% by mass resin solution; and
a step of passing the obtained resin solution through a column chromatograph to fractionate a reclaimed polycarbonate resin.
   <2> The method according to item <1>, wherein the column chromatograph is a simulated moving bed chromatograph.
   <3> The method according to item <1> or <2>, wherein the organic solvent is methylene chloride.
   <4> The method according to any one of items <1> to <3>, wherein two or more reclaimed polycarbonate resins having different viscosity average molecular weights (Mv) are fractionated from the waste resin composition.
   <5> The method according to item <4>, wherein when the viscosity average molecular weights (Mv) of the two or more reclaimed polycarbonate resins are Mv₁, Mv₂, Mv₃, . . . MVₙ, and MVₙ₊₁, the resolution (Mvₚ/MVₙ₊₁) is 2.0 or less.
   <6> The method according to any one of items <1> to <5>, wherein the reclaimed polycarbonate is a bisphenol A-type polycarbonate resin.
   <7> A molded body comprising a reclaimed polycarbonate resin obtained by the method according to any one of items <1> to <6>.

### Advantageous Effect of the Invention

According to the present invention, by using a column chromatograph (preferably a simulated moving bed chromatograph), a high-quality reclaimed polycarbonate resin can be obtained from a resin product (molded body, etc.) containing a waste polycarbonate resin continuously without high energy consumption by a simple method. Further, according to a preferred aspect of the present invention, reclaimed polycarbonate resins having different viscosity average molecular weights can be obtained from a waste polycarbonate resin by means of separation (fractionation/collection).

### EMBODIMENTS FOR CARRYING OUT THE INVENTION

Hereinafter, the present invention will be described in detail by way of working examples, etc., but the present invention is not limited thereto and can be arbitrarily changed and then practiced within a range not departing from the gist of the present invention.

One embodiment of the present invention is a method for producing a reclaimed polycarbonate resin from a waste resin composition containing at least a polycarbonate resin, the method including: a step of dissolving the waste resin composition in an organic solvent and performing filtration to prepare a 1 to 30% by mass resin solution; and a step of passing the obtained resin solution through a column chromatograph to fractionate a reclaimed polycarbonate resin.

In the waste resin composition, at least a polycarbonate resin is contained, and other than that, for example, a polyarylate resin, an acrylic resin, a polyester resin, a polyestercarbonate resin, a polyethylene terephthalate resin, various rubbers, various elastomer resins, an ABS resin, a polyolefin resin, a polybutylene terephthalate resin, monomers thereof, etc. may also be contained. In this case, according to the present invention, when a reclaimed polycarbonate resin is produced, resins other than the polycarbonate resin and monomers such as those described above can be produced (fractionated) at the same time.

In the present invention, examples of the organic solvent for dissolving the waste resin composition include methylene chloride, tetrahydrofuran, methyl ethyl ketone, acetone, methanol, ethanol, and toluene, and it is preferred that methylene chloride is included. These organic solvents may be used solely, or two or more of them may be used in combination.

In the present invention, filtration is performed for the purpose of, for example, removing components in the waste resin composition that do not dissolve in the organic solvent, and filtration is preferably performed using a paper filter, a membrane filter (screen filter), a metal filter that is a filter made of a metal in which a metal nonwoven fabric or wire mesh is used as a filter material, any of polymer filters (leaf disk type, pleated type, candle type, pack disk type, cylindrical type, etc.), or the like, and filtration is more preferably performed using a leaf disk type polymer filter that has a large effective filtration area. The mesh of the polymer filter is preferably 500 μm or less, more preferably 100 μm or less, and particularly preferably 30 μm or less.

In the present invention, the concentration of the resin solution obtained after the above-described filtration is 1 to 30% by mass, preferably 5 to 20% by mass, and more preferably 10 to 20% by mass.

When the concentration of the resin solution is less than 1% by mass, the productivity of the polycarbonate resin is deteriorated, and when the concentration is more than 30% by mass, the viscosity of the resin solution increases rapidly, and problems such as an increase in the internal pressure of a column chromatograph and resin precipitation tend to occur. Further, the separation ability is deteriorated.

When only the filtration process is considered, a resin solution having a lower concentration is advantageous because it is easier to perform filtration, while a resin solution having a higher concentration is disadvantageous because it is more difficult to perform filtration. The optimum concentration can be determined by balancing with productivity and decrease of the amount of a solvent used as much as possible.

In the present invention, the obtained resin solution is passed through a column chromatograph to fractionate a reclaimed polycarbonate resin. As the column chromatograph, a fixed bed chromatograph, a moving bed chromatograph, a multicomponent separation and circulation type chromatograph, a simulated moving bed chromatograph (also known as a reverse phase chromatograph) or the like can be used, and a simulated moving bed chromatograph is preferably used from the viewpoint of good separation ability, the possibility of increasing in size, and the system in which a solvent is easily recovered and recycled.

The simulated moving bed chromatograph preferably used in the present invention is not particularly limited, but it is preferred to use the simulated moving bed chromatograph described in Japanese Laid-Open Patent Publication No. H11-228455.

In a preferred embodiment of the present invention, two or more reclaimed polycarbonate resins having different viscosity average molecular weights (Mv) can be fractionated from the waste resin composition.

In the present invention, as the method for measuring the viscosity average molecular weight (Mv), the method described in the Examples below can be used.

In a preferred embodiment of the present invention, when the viscosity average molecular weights (Mv) of the two or more reclaimed polycarbonate resins are Mv₁, Mv₂, Mv₃, . . . . Mvₙ, and MVₙ₊₁, the resolution (Mvₙ/Mvₙ₊₁) is preferably 2.0 or less, more preferably 1.1 to 1.6, even more preferably 1.1 to 1.5, and particularly preferably 1.2 to 1.4. When the resolution (Mvₙ/MVₙ₊₁) exceeds 2.0, separation is insufficient, and the quality of a polycarbonate obtained may be reduced.

According to the present invention, any type of polycarbonate resin can be reclaimed, but the reclaimed polycarbonate is preferably a bisphenol A-type polycarbonate resin, since it has a relatively stable structure, it is technically easily separated, it is a type that is excreted in large quantities in the world, and reclaiming thereof is very important.

The reclaimed polycarbonate resin thus obtained is preferably used for the production of molded bodies.

Further, the present invention can also be applied to a polycarbonate resin obtained from a diol represented by general formula (2-1) or (2-2) below:

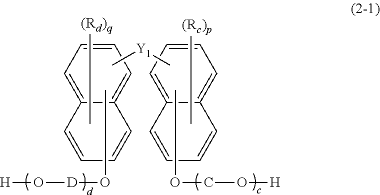

(In general formula (2-1):
R_{c} and R_{d} are each independently selected from the group consisting of a hydrogen atom; a halogen atom; a substituted or unsubstituted alkyl group having 1 to 20 carbon atoms; a substituted or unsubstituted alkoxyl group having 1 to 20 carbon atoms; a substituted or unsubstituted cycloalkyl group having 5 to 20 carbon atoms; a substituted or unsubstituted cycloalkoxyl group having 5 to 20 carbon atoms; a substituted or unsubstituted aryl group having 6 to 20 carbon atoms; a substituted or unsubstituted heteroaryl group having 6 to 20 carbon atoms which contains at least one heterocyclic atom selected from O, N and S; a substituted or unsubstituted aryloxy group having 6 to 20 carbon atoms; and —C≡C—Rₕ₃;
Rₕ₃ represents a substituted or unsubstituted aryl group having 6 to 20 carbon atoms, or a substituted or unsubstituted heteroaryl group having 6 to 20 carbon atoms which contains at least one heterocyclic atom selected from O, N and S;
Y₁ represents a single bond or a substituted or unsubstituted fluorene group;
C and D each independently represent a substituted or unsubstituted alkylene group having 1 to 5 carbon atoms;
p and q each independently represent an integer of 0 to 6; and
c and d each independently represent an integer of 0 to 10.)

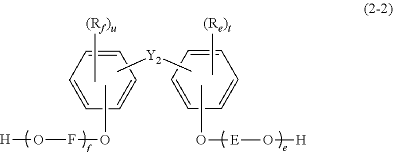

(In general formula (2-2):
Rₑ and R_{f} are each independently selected from the group consisting of a hydrogen atom, a halogen atom, a substituted or unsubstituted alkyl group having 1 to 20 carbon atoms, a substituted or unsubstituted alkoxyl group having 1 to 20 carbon atoms, a substituted or unsubstituted cycloalkyl group having 5 to 20 carbon atoms, a substituted or unsubstituted cycloalkoxyl group having 5 to 20 carbon atoms, and a substituted or unsubstituted aryl group having 6 to 20 carbon atoms;
Y₂ represents a single bond, a substituted or unsubstituted fluorene group, or any one of structural formulae represented by formulae (8) to (15):

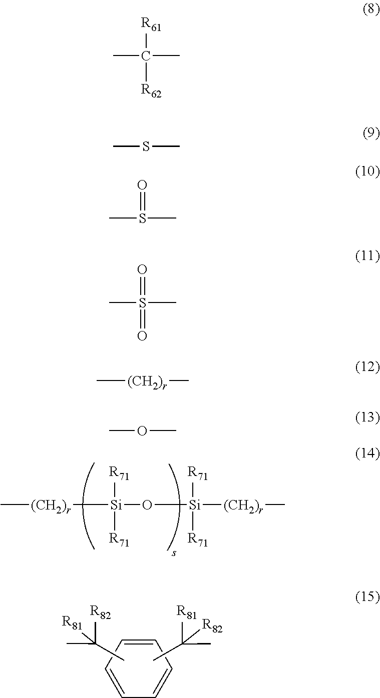

(wherein in formulae (8) to (15):
R₆₁, R₆₂, R₇₁, R₇₂, R₈₁ and R₈₂ each independently represent a hydrogen atom, a halogen atom, a substituted or unsubstituted alkyl group having 1 to 20 carbon atoms, or a substituted or unsubstituted aryl group having 6 to 30 carbon atoms, or represent a substituted or unsubstituted carbocyclic ring or heterocyclic ring having 1 to 20 carbon atoms, wherein R₆₁ and R₆₂, or R₇₁ and R₇₂, are bonded to each other, and
r and s each independently represent an integer of 0 to 5000);
E and F each independently represent a substituted or unsubstituted alkylene group having 1 to 5 carbon atoms;
t and u each independently represent an integer of 0 to 4; and
e and f each independently represent an integer of 0 to 10.)

### EXAMPLES

Hereinafter, the present invention will be described in detail by way of a working example, but the present invention is not limited thereto.

### <Viscosity Average Molecular Weight (Mv)>

Measurement apparatus: Ubbelohde capillary viscometer
Solvent: dichloromethane
Concentration of resin solution: 0.5 gram/deciliter
Measurement temperature: 25° C.

The measurement was carried out under the above-described conditions to determine a limiting viscosity [η] deciliter/gram with a Huggins constant of 0.45, and calculation was made according to formula below.

$$η = 1.23 \text{?} {10}^{- 4} \times Mn \text{?}$$

$$\text{?} \text{indicates text missing or illegible when filed}$$

### Example 1

A plastic molded article containing a polycarbonate resin was dissolved in methylene chloride, and the mixture was filtered using a 20-μm mesh leaf disk type polymer filter to prepare a 15% by mass resin solution. The obtained resin solution was passed through a simulated moving bed chromatograph. A cycle, in which flow channel switching was performed intermittently 12 times by controlling opening and closing of an electromagnetic valve using a sequencer, was performed to carry out fractionation repeatedly.

Details of the simulated moving bed chromatograph are as described below.
Apparatus: It was based on the simulated moving bed chromatograph described in Japanese Laid-Open Patent Publication No. H11-228455.
Column: stainless steel column (with heating jacket)
   inner diameter: 1.2 cm, length: 60 cm, 12 columns, connected in series, filled with porous gel
Temperature: 60° C.
Time for one cycle: 250 minutes
Supply flow rate: total 10.2 ml/min
   Supply flow rate of resin solution: 1.0 ml/min
   Supply flow rate of eluent: methylene chloride, 9.2 ml/min
Discharge flow rate: total 10.2 ml/min
   Weakly adsorbent fractionated component: 2.8 ml/min
   Medium-level adsorbent fractionated component: 3.4 ml/min
   Strongly adsorbent fractionated component: 4.0 ml/min

Methylene chloride was evaporated from solutions collected from each of the adsorbent fractionated components 400 to 450 minutes after the start of the fractionation operation to obtain polycarbonate resins. The viscosity average molecular weights (Mv) of the obtained resins were as described below.
Weakly adsorbent fractionated component: 28,000
Medium-level adsorbent fractionated component: 21,500
Strongly adsorbent fractionated component: 16,000

The resolutions (Mvₙ/MVₙ₊₁) were 1.30 (Mv of weakly adsorbent fractionated component/Mv of medium-level adsorbent fractionated component) and 1.34 (Mv of medium-level adsorbent fractionated component/Mv of strongly adsorbent fractionated component).

1. A method for producing a reclaimed polycarbonate resin from a waste resin composition containing at least a polycarbonate resin, the method comprising:
dissolving the waste resin composition in an organic solvent and performing filtration to prepare a 1 to 30% by mass resin solution; and
passing the obtained resin solution through a column chromatograph to fractionate a reclaimed polycarbonate resin.

2. The method according to claim 1, wherein the column chromatograph is a simulated moving bed chromatograph.

3. The method according to claim 1, wherein the organic solvent is methylene chloride.

4. The method according to claim 1, wherein two or more reclaimed polycarbonate resins having different viscosity average molecular weights (Mv) are fractionated from the waste resin composition.

5. The method according to claim 4, wherein when the viscosity average molecular weights (Mv) of the two or more reclaimed polycarbonate resins are Mv₁, Mv₂, Mv₃, . . . Mvₙ, and Mvₙ₊₁, a resolution (Mvₚ/MVₙ₊₁) is 2.0 or less.

6. The method according to claim 1, wherein the reclaimed polycarbonate is a bisphenol A-type polycarbonate resin.

7. A molded body comprising a reclaimed polycarbonate resin obtained by the method according to claim 1.
